(19) United States
(12) Patent Application Publication
(10) Pub. No.: US 2010/0020472 A1
(43) Pub. Date: Jan. 28, 2010

(54) ELECTROLYTIC CAPACITOR AND METHOD OF MAKING THE SAME

(75) Inventor: Kazumasa Fujimoto, Saga-gun (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: SANYO ELECTRIC CO., LTD., Moriguchi-shi, Osaka (JP); SAGA SANYO INDUSTRIES CO., LTD., Kishima-gun, Saga (JP)

(21) Appl. No.: 12/515,755

(22) PCT Filed: Sep. 27, 2007
(86) PCT No.: PCT/JP2007/068882

§ 371 Date: May 21, 2009

(30) Foreign Application Priority Data
Nov. 22, 2006 (JP) 2006-315283

(51) Int. Cl. H01G 9/042

(52) U.S. Cl. 361/511; 361/516; 29/25.03

(57) ABSTRACT

Object: To provide an electrolytic capacitor operable without a separator sheet. Means For Solving Problems: An electrolytic capacitor comprises an oxidized anode foil, a cathode foil, a securing tape, lead tab terminals, an anode lead, and a cathode lead. A surface of the oxidized anode foil and the cathode foil is coated with polythiophene-group conductive polymer. The lead tab terminal is connected to the oxidized anode foil, and the lead tab terminal is connected to the cathode foil. The anode lead is connected to the lead tab terminal, and the cathode lead is connected to the lead tab terminal. The oxidized anode foil and the cathode foil, to which the lead tab terminals, the anode lead and the cathode lead are connected, are rolled up without interposing a separator sheet therebetween and sealed up with the securing tape. In this manner, a capacitor element is made.

### TECHNICAL FIELD

The present invention relates to winding electrolytic capacitors and methods of making the same.

### BACKGROUND ART

Following the recent demand for electrical circuits that are smaller in size and adapted for high-frequency, capacitors with lower impedance have been required. In particular, absorption of high-frequency noise and ripple current is required in designing driving circuits for CPUs (Central Processing Units) of computers, switching power supply circuits and the like, and therefore, capacitors with low ESR (Equivalent Series Resistance) are required.

Winding electrolytic capacitors attract attention for their ESR that can be made low. Patent Document 1 discloses a well-known electrolytic capacitor with high capacitance. This electrolytic capacitor comprises an anode foil, a cathode foil and a separator sheet placed therebetween, which are rolled up together.

### Patent Document 1: Japanese Unexamined Patent Application Publication No. 2003-142345.

### DISCLOSURE OF INVENTION

### Problems to be Solved by the Invention

Conventional electrolytic capacitors are problematic in that, being in need of securing the insulation property of the capacitors, it is hard to remove the separator sheet.

The present invention is aimed at solving the aforementioned problem, and one of its objects is to provide an electrolytic capacitor operable without a separator sheet.

Another object of the present invention is to provide a method of making an electrolytic capacitor operable without a separator sheet.

### Means for Solving the Problems

According to the present invention, an electrolytic capacitor comprises an anode member and a cathode member. The cathode member is rolled with the anode member without interposing a separator sheet therebetween.

According to the present invention, an electrolytic capacitor is a winding electrolytic capacitor, which is operable without a separator sheet, comprises an anode member and a cathode member. A surface of the anode member is coated with conductive polymer. The cathode member a surface of which is coated with conductive polymer is rolled with the anode member.

Preferably, the electrolytic capacitor further comprises a conductive polymer layer. The conductive polymer layer is formed in a gap.

Preferably, the conductive polymer is formed of at least one of aliphatic-group, aromatic-group, heterocyclic-group, and heteroatomic-group conductive polymers.

Further, according to the present invention, an electrolytic capacitor comprises an anode member, a cathode member, and a conductive polymer film. The cathode member is rolled with the anode member. The conductive polymer film is disposed between the anode member and the cathode member and rolled with the anode member and the cathode member.

Further, according to the present invention, a method of making an electrolytic capacitor comprises a first step of making an anode member and a cathode member and a second step of rolling up the anode member and the cathode member without interposing a separator sheet therebetween.

Further, according to the present invention, a method of making an electrolytic capacitor comprises a first step of making an anode member and a cathode member by coating a surface of metal foil with conductive polymer and a second step of rolling up the anode member and the cathode member in a manner where the cathode member faces the anode member.

Further, according to the present invention, a method of making an electrolytic capacitor comprises a first step of making an anode member and a cathode member and a second step of rolling up the anode member, a conductive polymer film and the cathode member in a manner where the cathode member and the anode member face each other across the conductive polymer film.

Preferably, the method of making an electrolytic capacitor further comprises a third step of forming a conductive polymer layer in a gap after the second step.

Preferably, the method of making an electrolytic capacitor further comprises a third step of impregnating with an electrolyte after the second step.

### ADVANTAGEOUS EFFECT OF THE INVENTION

An electrolytic capacitor according to the present invention comprises an anode member and a cathode member, which are rolled together without interposing a separator sheet therebetween.

Further, an electrolytic capacitor according to the present invention comprises an anode member and a cathode member, which are rolled together with a conductive polymer film interposed therebetween.

Further, an electrolytic capacitor according to the present invention comprises an anode member and a cathode member, which are coated with conductive polymer and rolled together without interposing a separator sheet therebetween.

Further, an electrolytic capacitor according to the present invention comprises an anode member and a cathode member, which are coated with conductive polymer and rolled together with a conductive polymer layer that is formed of by means of polymerization and.

Therefore, according to the present invention, an electrolytic capacitor is made without a separator sheet.

### BEST MODES FOR CARRYING OUT THE INVENTION

The present invention will now be described in embodiments with reference to the drawings more specifically. In the figures, identical or like components are identically denoted by the same reference characters and explanations thereof are not repeated.

### Embodiment 1

FIG. 1 is a perspective view illustrating the structure of an electrolytic capacitor according to Embodiment 1 of the present invention. FIG. 2 is a cross sectional view of the structure of the electrolytic capacitor according to Embodiment 1 of the present invention. With reference to FIGS. 1 and 2, an electrolytic capacitor 10 according to Embodiment 1 of the present invention comprises an oxidized anode foil 1, a cathode foil 2, a securing tape 3, lead tab terminals 6 and 7, an anode lead 8, a cathode lead 9, a case 11, a sealing rubber packing 12, and a seat plate 13.

The electrolytic capacitor 10 includes a solid electrolyte, for example.

The oxidized anode foil 1 is formed of aluminum foil a surface of which has been processed by chemical conversion treatment and coated with conductive polymer. Therefore, the surface of the oxidized anode foil 1 becomes rough and has an oxide layer thereon and conductive polymer. The cathode foil 2 is formed of aluminum foil that is coated with conductive polymer.

The oxidized anode foil 1 and the cathode foil 2 are placed together and then rolled up. After that, the end of the rolled stack of the oxidized anode foil 1 and the cathode foil 2 is sealed up with the securing tape 3. In this manner, a capacitor element 5 that is substantially cylindrical is formed. As described here, in the electrolytic capacitor 10, the oxidized anode foil 1 and the cathode foil 2 are rolled up without interposing a separator sheet therebetween.

The lead tab terminal 6 is connected to the oxidized anode foil 1, and the lead tab terminal 7 is connected to the cathode foil 2. The anode lead 8 is connected to the lead tab terminal 6, and the cathode lead 9 is connected to the lead tab terminal 7.

The case 11 is formed of aluminum and houses the capacitor element 5, the lead tab terminals 6 and 7, the anode lead 8, and the cathode lead 9. The sealing rubber packing 12 seals up the capacitor element 5 and the lead tab terminals 6 and 7 in the case 11. The seat plate 13 fixes the anode lead 8 and the cathode lead 9. The anode lead 8 and the cathode lead 9 are bent along the seat plate 13 when the capacitor element 5 is placed in the case 11.

FIG. 3 is a plan view of the electrolytic capacitor 10 viewed along A direction shown in FIG. 2. With reference to FIG. 3, the seat plate 13 is substantially rectangular in a plane shape and has cutouts 13A and 13B. The anode lead 8 and the cathode lead 9 are bent inward so as to respectively fit into the cutouts 13A and 13B of the seat plate 13.

The bent anode lead 8 and cathode lead 9 are used as terminals for the electrolytic capacitor 10.

FIG. 4 is a cross sectional view of the oxidized anode foil 1 shown in FIG. 1. With reference to FIG. 4, the oxidized anode foil 1 comprises a metal foil 101, and conductive polymer layers 102 and 103. The metal foil 101 is formed of aluminum foil that has been etched and processed by chemical conversion treatment. Note that the etched surface of the aluminum foil is rough, however, in FIG. 4, the metal foil 101 is illustrated as having the smooth surface in order to explain the cross sectional structure of the oxidized anode foil 1.

The conductive polymer layer 102 includes polythiophene-group conductive polymer and is formed on a surface of the metal foil 101. The conductive polymer layer 103 includes 3,4-ethylenedioxythiophene and is formed in a manner where contact is made with the conductive polymer layer 102.

As described above, the oxidized anode foil 1 comprises the two conductive polymer layers 102 and 130 that are formed on a surface of the metal foil 101.

Note that the cathode foil 2 shown in FIG. 1 has the same cross sectional structure as that of the oxidized anode foil 1 shown in FIG. 4.

FIG. 5 is a flowchart illustrating how to make the electrolytic capacitor 10 shown in FIGS. 1 and 2. With reference to FIG. 5, a sheet of aluminum foil is cut into a certain size (of length L and width W), a surface of the aluminum foil is etched, processed by means of chemical conversion treatment and coated with polythiophene-group conductive polymer to form a sheet of oxidized anode foil 1. Likewise, a sheet of aluminum foil is cut into a certain size (of length L and width W), a surface of the aluminum foil is etched, processed by means of chemical conversion treatment and coated with polythiophene-group conductive polymer to form a sheet of cathode foil 2 (Step S1). This coating process of polythiophene-group conductive polymer forms the conductive polymer layer 102 on a surface of the metal foil 101.

Then, the oxidized anode foil 1 and the cathode foil 2 are placed so as to face each other and rolled up. The end of the rolled stack of the oxidized anode foil 1 and the cathode foil 2 is sealed with the securing tape 3, and the capacitor element 5 is formed (Step S2). More specifically, the capacitor element 5 is formed by rolling up the oxidized anode foil 1 and the cathode foil 2 without interposing a separator sheet therebetween. After that, the capacitor element 5 is processed by chemical conversion treatment (Step S3) and is impregnated with a mixed solution of 3,4-ethylenedioxythiophene that forms conductive polymer by polymerization and ferric p-toluenesulfonic acid alcohol solution as an oxidant solution (Step S4). This impregnation with the mixed solution forms the conductive polymer layer 103 on the conductive polymer layer 102 More specifically, when the capacitor element 5 is impregnated with the mixed solution, the mixed solution permeates the capacitor element 5 through a gap between the rolled oxidized anode foil 1 and cathode foil 2, and the conductive polymer layer 103 is formed therein. Therefore, the conductive polymer layer 103 is formed in a gap between the oxidized anode foil 1 and the cathode foil 2. The conductive polymer layer 103 is an electrolyte, and therefore, Step S4 is a step to full a gap between the oxidized anode foil 1 and the cathode foil 2 with an electrolyte.

Then, the sealing rubber packing 12 is inserted onto the capacitor element 5. The capacitor element 5 and the sealing rubber packing 12 inserted thereon are housed in the case 11 (Step S5). The opening of the case 11 is pressed and curled to seal the capacitor element 5 in the case 11 (Step S6).

Then, the capacitor element 5 is aged (Step S7), and the seat plate 13 that is formed of plastic is inserted onto the curled open end of the case 11 (Step S8). Then, the anode lead 8 and the cathode lead 9 are pressed for use as electrode terminals and bent along the seat plate 13 to form electrodes (Step S9). In this manner, the electrolytic capacitor 10 is completed.

FIG. 6 illustrates how to roll the oxidized anode foil 1 and the cathode foil 2. With reference to FIG. 6, to roll up the oxidized anode foil 1 and the cathode foil 2, the oxidized anode foil 1 and the cathode foil 2 are placed as illustrated in FIG. 6. Then, the oxidized anode foil 1 and the cathode foil 2 are wound counterclockwise (or clockwise) so as to pivot around a pivot point FLC to be rolled up. In this manner, the capacitor element 5 is formed. Therefore, in Step S2 shown in FIG. 5, the oxidized anode foil 1 and the cathode foil 2 are rolled up by means of the method shown in FIG. 6, and the capacitor element 5 is formed.

As described above, the electrolytic capacitor 10 comprises the oxidized anode foil 1 and the cathode foil 2 that are rolled up without interposing a separator sheet therebetween.

### Embodiment 2

FIG. 7 is a perspective view illustrating the structure of an electrolytic capacitor according to Embodiment 2. With reference to FIG. 7, an electrolytic capacitor 10A according to Embodiment 2 is identical with the electrolytic capacitor 10 shown in FIG. 1 except that the oxidized anode foil 1 and the cathode foil 2 of the electrolytic capacitor 10 are respectively replaced with an oxidized anode foil 1A and a cathode foil 2A.

The oxidized anode foil 1A and the cathode foil 2A are rolled up in a manner where contact is made, and sealed up with the securing tape 3. In this manner, the capacitor element 5 is formed. More specifically, the oxidized anode foil 1A and the cathode foil 2A are rolled up without interposing a separator sheet therebetween, and the capacitor element 5 is formed.

FIG. 8 is a cross sectional view of the oxidized anode foil 1A shown in FIG. 7. With reference to FIG. 8, the oxidized anode foil 1A is identical with the oxidized anode foil 1 shown in FIG. 4 except that the conductive polymer layer 103 of the oxidized anode foil 1 is removed. Note that the cathode foil 2A has the same cross sectional structure as that of the oxidized anode foil 1A shown in FIG. 8.

FIG. 9 is a flowchart illustrating how to make the electrolytic capacitor 10A shown in FIG. 7. The flowchart shown in FIG. 9 is identical with the flowchart of FIG. 5 except that Step S4 in FIG. 5 is eliminated.

Therefore, after the above-described Steps S1 to S3 are sequentially performed and the capacitor element 5 is processed by chemical conversion treatment (Step S3), now the sealing rubber packing 12 is inserted onto the capacitor element 5. Then, the capacitor element 5 and the sealing rubber packing 12 are housed in the case 11 (Step S5). Then, the above-described Steps S6 to S9 are sequentially performed.

As described above, the electrolytic capacitor 10A is formed without impregnating the capacitor element 5 with a mixed solution of 3,4-ethylenedioxythiophene and ferric p-toluenesulfonic acid alcohol solution. Therefore, as described above, the oxidized anode foil 1A and the cathode foil 2A comprise the metal foil 101 and the conductive polymer layer 102. The cross sectional structure of the oxidized anode foil 1A and the cathode foil 2A comprises no conductive polymer layer 103.

The rest is the same as Embodiment 1.

### Embodiment 3

FIG. 10 is a perspective view illustrating the structure of an electrolytic capacitor according to Embodiment 3. With reference to FIG. 10, an electrolytic capacitor 10B according to Embodiment 3 is identical with the electrolytic capacitor 10 shown in FIG. 1 except that the oxidized anode foil 1 and the cathode foil 2 of the electrolytic capacitor 10 are respectively replaced with an oxidized anode foil 1B and a cathode foil 2B.

The oxidized anode foil 1B and the cathode foil 2B are rolled up in a manner where contact is made and sealed up with the securing tape 3. In this manner, the capacitor element 5 is formed. More specifically, the capacitor element 5 is formed by rolling up the oxidized anode foil 1B and the cathode foil 2B without interposing a separator sheet therebetween.

FIG. 11 is a cross sectional view of the oxidized anode foil 1B shown in FIG. 10. With reference to FIG. 11, the oxidized anode foil 1B is identical with the oxidized anode foil 1 shown in FIG. 4 except that the conductive polymer layer 102 of the oxidized anode foil 1 is replaced with a conductive polymer layer 102A.

The conductive polymer layer 102A includes polyaniline-group conductive polymer and is formed between the metal foil 101 and the conductive polymer layer 103 in a manner where contact is made with the metal foil 101 and the conductive polymer layer 103. Note that the cathode foil 2B has the same cross sectional structure as that of the oxidized anode foil 1B shown in FIG. 11.

FIG. 12 is a flowchart illustrating how to make the electrolytic capacitor 10B shown in FIG. 10. The flowchart shown in FIG. 12 is identical with the flowchart of FIG. 5 except that Step S1 of the flowchart shown in FIG. 5 is replaced with Step S1A.

With reference to FIG. 12, once fabrication of the electrolytic capacitor 10B is started, a sheet of aluminum foil is cut into a certain size (of length L and width W), and a surface of the aluminum foil is etched, processed by chemical conversion treatment and coated with polyaniline-group conductive polymer to form a sheet of oxidized anode foil 1B. Likewise, a sheet of aluminum foil is cut into a certain size (of length L and width W), and a surface of the aluminum foil is etched, processed by chemical conversion treatment and coated with polyaniline-group conductive polymer to form a sheet of cathode foil 2B (Step S1A). This coating process of polyaniline-group conductive polymer forms the conductive polymer layer 102A on a surface of the metal foil 101.

After that, the above-described Steps S2 to S9 are sequentially performed, and the electrolytic capacitor 10B is formed. In this case, when the capacitor element 5 comprising the rolled oxidized anode foil 1B and cathode foil 2B is impregnated with a mixed solution of 3,4-ethylenedioxythiophene and ferric p-toluenesulfonic acid alcohol solution, the mixed solution permeates the capacitor element 5 through a gap between the rolled oxidized anode foil 1B and cathode foil 2B, and the conductive polymer layer 103 is formed therein. As a result, the cross sectional structure of the oxidized anode foil 1B and the cathode foil 2B is as illustrated in FIG. 11.

Therefore, the electrolytic capacitor 10B is different from the electrolytic capacitor 10 in that the conductive polymer layer 102A formed on a surface of the metal foil 101 is different from the conductive polymer layer 102.

The rest is the same as Embodiment 1.

### Embodiment 4

FIG. 13 is a perspective view illustrating the structure of an electrolytic capacitor according to Embodiment 4. With reference to FIG. 13, an electrolytic capacitor 10C according to Embodiment 4 is identical with the electrolytic capacitor 10B shown in FIG. 10 except that the oxidized anode foil 1B and the cathode foil 2B of the electrolytic capacitor 10B are respectively replaced with an oxidized anode foil 1C and a cathode foil 2C.

The oxidized anode foil 1C and the cathode foil 2C are rolled up in a manner where contact is made and sealed up with the securing tape 3. In this manner, the capacitor element 5 is formed. More specifically, the capacitor element 5 is formed by rolling up the oxidized anode foil 1C and the cathode foil 2C without interposing a separator sheet therebetween.

FIG. 14 is a cross sectional view of the oxidized anode foil 1C shown in FIG. 13. With reference to FIG. 14, the oxidized anode foil 1C is identical with the oxidized anode foil 1B shown in FIG. 11 except that the conductive polymer layer 103 of the oxidized anode foil 1B is removed. Note that the cathode foil 2C has the same cross sectional structure as that of the oxidized anode foil 1C shown in FIG. 14.

FIG. 15 is a flowchart illustrating how to make the electrolytic capacitor 10C shown in FIG. 13. The flowchart shown in FIG. 15 is identical with the flowchart of FIG. 12 except that Step S4 of the flowchart shown in FIG. 12 is eliminated.

Therefore, after the above-described Steps S1A, S2 and S3 are sequentially performed and the capacitor element 5 is processed by chemical conversion treatment (Step S3), now the sealing rubber packing 12 is inserted onto the capacitor element 5, and the capacitor element 5 and the sealing rubber packing 12 are housed in the case 11 (Step S5). Then, the above-described Steps S6 to S9 are sequentially performed.

As described above, the electrolytic capacitor 10C is formed without impregnating the capacitor element 5 with a mixed solution of 3,4-ethylenedioxythiophene and ferric p-toluenesulfonic acid alcohol solution. Therefore, as described above, the oxidized anode foil 1C and the cathode foil 2C comprise the metal foil 101 and the conductive polymer layer 102A. The cross sectional structure of the oxidized anode foil 1C and the cathode foil 2C comprises no conductive polymer layer 103.

The rest is the same as Embodiments 1 and 3.

### Embodiment 5

FIG. 16 is a perspective view illustrating the structure of an electrolytic capacitor according to Embodiment 5. With reference to FIG. 16, an electrolytic capacitor 10D according to Embodiment 5 is identical with the electrolytic capacitor 10 shown in FIG. 1 except that the oxidized anode foil 1 and the cathode foil 2 of the electrolytic capacitor 10 are respectively replaced with an oxidized anode foil 1D and a cathode foil 2D and that a conductive polymer film 15 is added.

The oxidized anode foil 1D and the cathode foil 2D are rolled with the conductive polymer film 15 interposed therebetween, and sealed with the securing tape 3. In this case, the conductive polymer film 15 may be bigger or smaller than the oxidized anode foil 1D and the cathode foil 2D.

FIG. 17 is a cross sectional view of part of the rolled stack of the oxidized anode foil 1D, the cathode foil 2D and the conductive polymer film 15. With reference to FIG. 17, the oxidized anode foil 1D and the cathode foil 2D comprise the metal foil 101 and the conductive polymer layer 103. The conductive polymer layer 103 is formed on a surface of the metal foil 101.

The conductive polymer film 15 is disposed between the two conductive polymer layers 103 of the oxidized anode foil 1D and the cathode foil 2D and makes contact with both of the conductive polymer layers 103.

FIG. 18 is a flowchart illustrating how to make the electrolytic capacitor 10D shown in FIG. 16. The flowchart shown in FIG. 18 is identical with the flowchart of FIG. 5 except that Steps S1 and S2 of the flowchart shown in FIG. 5 are respectively replaced with Steps S1B and 2A.

With reference to FIG. 18, once fabrication of the electrolytic capacitor 10D is started, a sheet of aluminum foil is cut into a certain size (of length L and width W), and a surface of the aluminum foil is etched and processed by chemical conversion treatment to form a sheet of oxidized anode foil 1D. Likewise, a sheet of aluminum foil is cut into a certain size (of length L and width W), and a surface of the aluminum foil is etched and processed by chemical conversion treatment to form a sheet of cathode foil 2D (Step S1B). More specifically, the oxidized anode foil 1D and the cathode foil 2D are formed without coating a surface of the aluminum foil with conductive polymer.

Then, the capacitor element 5 is formed by interposing the conductive polymer film 15 between the oxidized anode foil 1D and the cathode foil 2D and then rolling up the oxidized anode foil 1D, the cathode foil 2D and the conductive polymer film 15 together (Step S2A).

After that, the above-described Steps S3 to S9 are sequentially performed, and the electrolytic capacitor 10D is formed. In this case, when the capacitor element 5 comprising the rolled oxidized anode foil 1D and cathode foil 2D is impregnated with a mixed solution of 3,4-ethylenedioxythiophene and ferric p-toluenesulfonic acid alcohol solution, the mixed solution permeates the capacitor element 5 through a gap between the rolled oxidized anode foil 1D and cathode foil 2D, and the conductive polymer layer 103 is formed on a surface of the metal foil 101. As a result, the cross sectional structure of the oxidized anode foil 1D and the cathode foil 2D is as illustrated in FIG. 17.

As described above, the electrolytic capacitor 10D is formed by using a metal foil having no conductive polymer coated on a surface.

The rest is the same as Embodiment 1.

The electrolytic capacitors 10, 10A, 10B, 10C, and 10D according to the above-described Embodiments 1 to 5 comprise no separator sheet. Without a separator sheet, it is important to secure the electrical insulation. Now, the electrical characteristics of the electrolytic capacitors 10, 10A, 10B, 10C, and 10D are explained below.

Table 1 represents measurement results of the electrical characteristics of the electrolytic capacitors 10, 10A, 10B, 10C, and 10D.

TABLE 1

| | | | | | | | | Leak |
|---|---|---|---|---|---|---|---|---|
| | Conductive Polymer | | | | Capacitance | tan δ | ESR | Current |
| | Group | Coating | Film | Permeation | (μF) | (%) | (mΩ) | (μA) |
| Embodiment 1 | Polythiophene- | Yes | — | Yes | 572 | 1.3 | 10 | 24 |
| Embodiment 2 | Group | Yes | — | — | 565 | 1.6 | 14 | 25 |
| Embodiment 3 | Polyaniline- | Yes | — | Yes | 563 | 1.4 | 16 | 27 |
| Embodiment 4 | Group | Yes | — | — | 560 | 1.8 | 20 | 26 |
| Embodiment 5 | Polythiophene- | — | Yes | Yes | 571 | 1.2 | 10 | 22 |
| | Group | | | | | | | |
| Conventional | — | — | — | Yes | 568 | 1.3 | 13 | 27 |
| Capacitor | | | | | | | | |

Note that, in Table 1, the measurement results of the electrical characteristics were obtained by averaging the measured values for thirty each of electrolytic capacitors of Embodiments 1 to 5 and conventional capacitors. The capacitance and the tan δ were measured at the frequency of 120 Hz, and the Equivalent Series Resistance was measured at the frequency of 100 kHz. The leak current was measured after two minutes of the application of the rated voltage.

As is understood from the measurement results in Table 1, the electrolytic capacitors 10, 10A, 10B, 10C, and 10D according to Embodiments 1 to 5 have the substantially same level of capacitance and leak current as those of conventional electrolytic capacitors. Therefore, it is possible to form an electrolytic capacitor without a separator sheet, while securing the electrical insulation.

Further, coating a surface with conductive polymer and formation of a conductive polymer layer by means of polymerization reduce the Equivalent Series Resistance (Refer to comparison between Embodiment 1 and Embodiment 2 and between Embodiment 3 and Embodiment 4). More specifically, combination use of coating with conductive polymer and impregnation with a mixed solution that forms conductive polymer by polymerization allows for fabrication of an electrolytic capacitor having the substantially same or better Equivalent Series Resistance than that of a conventional electrolytic capacitor.

Further, without coating with conductive polymer, an electrolytic capacitor having the Equivalent Series Resistance lower than that of a conventional electrolytic capacitor is formed by interposing a conductive polymer film between an oxidized anode foil and a cathode foil and then rolling them up together (Refer to the electrolytic capacitor according to Embodiment 5).

Accordingly, fabrication of an electrolytic capacitor without a separator sheet allows for a reduced Equivalent Series Resistance.

Further, without a separator sheet, an electrolytic capacitor comprising an oxidized anode foil and a cathode foil, which respectively have the same length as those of a conventional electrolytic capacitor, has the diameter smaller than that of the conventional electrolytic capacitor. More specifically, in this case, by using no separator sheet, an electrolytic capacitor is smaller in size.

On the other hand, if an electrolytic capacitor having the same diameter as a conventional electrolytic capacitor is formed without a separator sheet, the electrolytic capacitor has the capacitance that is 1.6 times larger than that of the conventional electrolytic capacitor. More specifically, in this case, by disposing no separator sheet, the capacitance of an electrolytic capacitor is increased.

It is described above that conductive polymer coating a surface of the metal foil 101 includes polythiophene-group conductive polymer or polyaniline-group conductive polymer. This invention, however, is not limited to them: The conductive polymer only has to include at least one of aliphatic-group, aromatic-group, heterocyclic-group, and heteroatomic-group conductive polymers.

The embodiments as have been described here are mere examples and should not be interpreted as restrictive. The scope of the present invention is determined by each of the claims, not by the written description of the embodiments, and embraces modifications within the meaning of, and equivalent to, the languages in the claims.

### INDUSTRIAL APPLICABILITY

The present invention is applied to an electrolytic capacitor operable without a separator sheet. The present invention is also applied to a method of making an electrolytic capacitor operable without a separator sheet.

### BRIEF DESCRIPTION OF DRAWINGS

FIG. 1 is a perspective view illustrating the structure of an electrolytic capacitor according to Embodiment 1 of the present invention.

FIG. 2 is a cross sectional view of the structure of the electrolytic capacitor according to Embodiment 1 of the present invention.

FIG. 3 is a plan view of the electrolytic capacitor viewed along A direction shown in FIG. 2.

FIG. 4 is a cross sectional view of the oxidized anode foil shown in FIG. 1.

FIG. 5 is a flowchart illustrating how to make the electrolytic capacitor shown in FIGS. 1 and 2.

FIG. 6 illustrates how to roll the oxidized anode foil and the cathode foil.

FIG. 7 is a perspective view illustrating the structure of an electrolytic capacitor according to Embodiment 2.

FIG. 8 is a cross sectional view of the oxidized anode foil shown in FIG. 7.

FIG. 9 is a flowchart illustrating how to make the electrolytic capacitor shown in FIG. 7.

FIG. 10 is a perspective view illustrating the structure of an electrolytic capacitor according to Embodiment 3.

FIG. 11 is a cross sectional view of the oxidized anode foil shown in FIG. 10.

FIG. 12 is a flowchart illustrating how to make the electrolytic capacitor shown in FIG. 10.

FIG. 13 is a perspective view illustrating the structure of an electrolytic capacitor according to Embodiment 4.

FIG. 14 is a cross sectional view of the oxidized anode foil shown in FIG. 13.

FIG. 15 is a flowchart illustrating how to make the electrolytic capacitor shown in FIG. 13.

FIG. 16 is a perspective view illustrating the structure of an electrolytic capacitor according to Embodiment 5.

FIG. 17 is a cross sectional view of part of the rolled stack of the oxidized anode foil, the cathode foil and the conductive polymer film.

FIG. 18 is a flowchart illustrating how to make the electrolytic capacitor shown in FIG. 16.

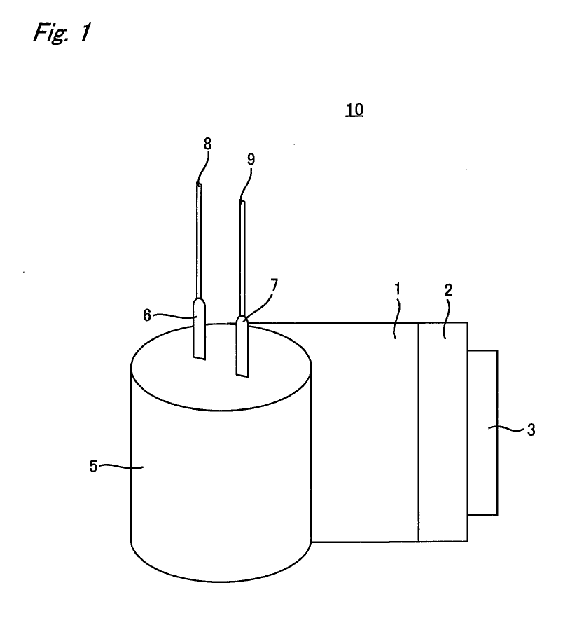

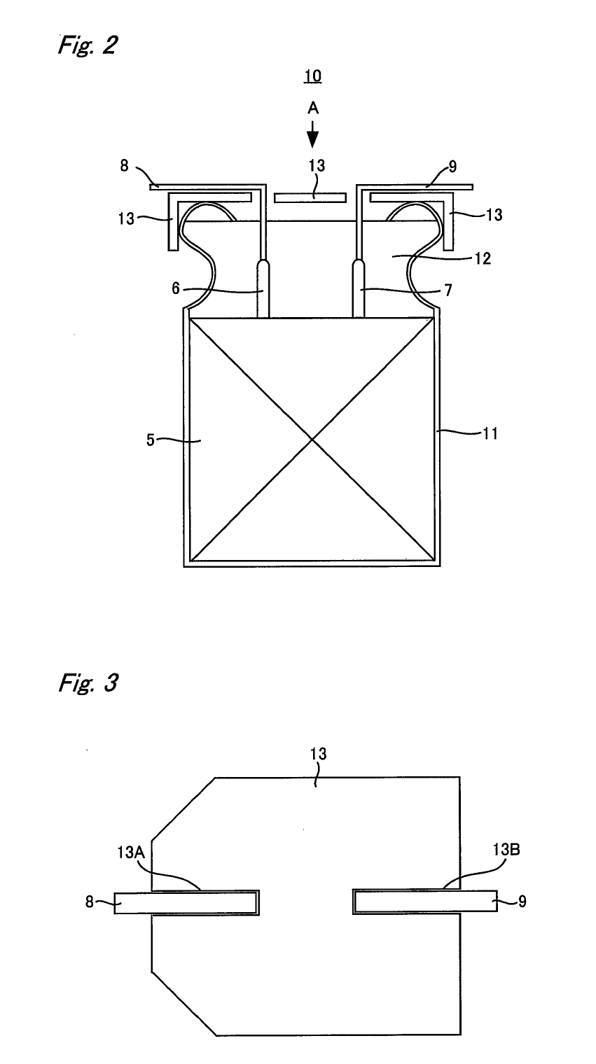

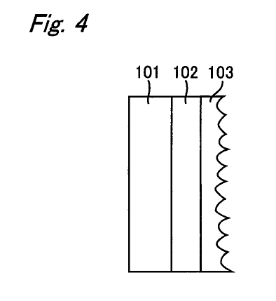

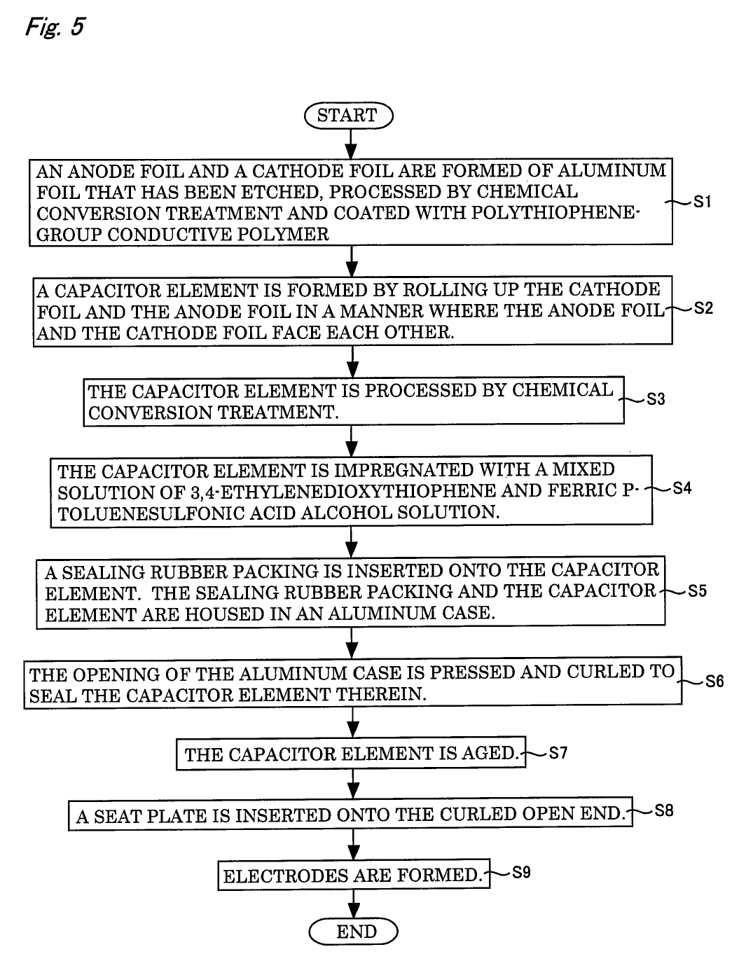

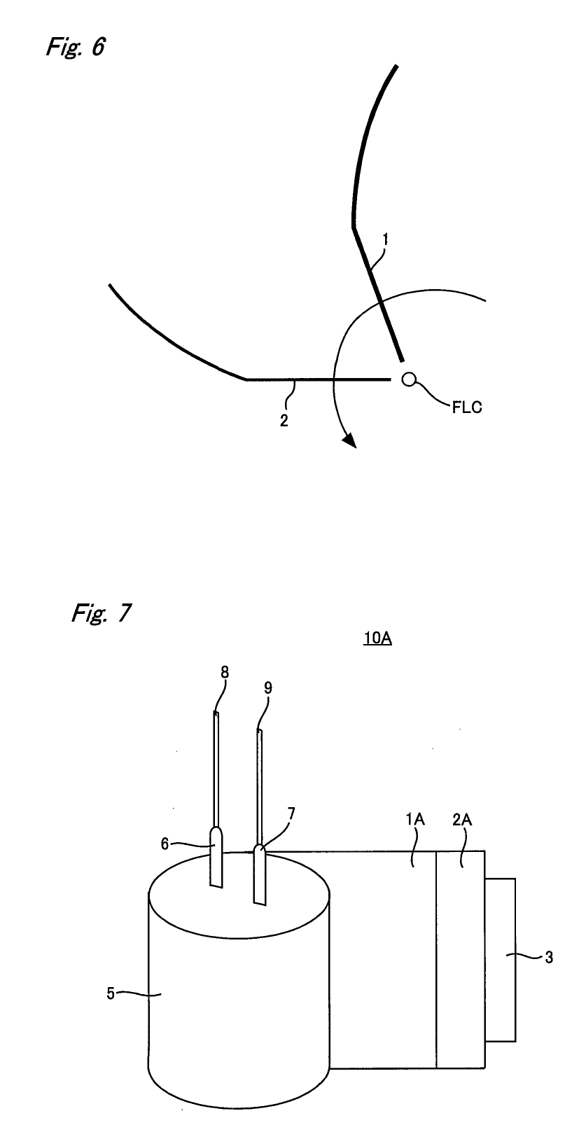

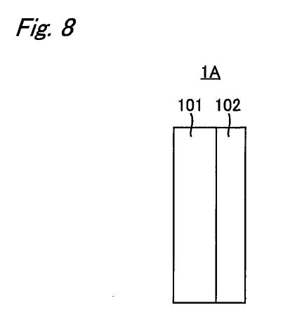

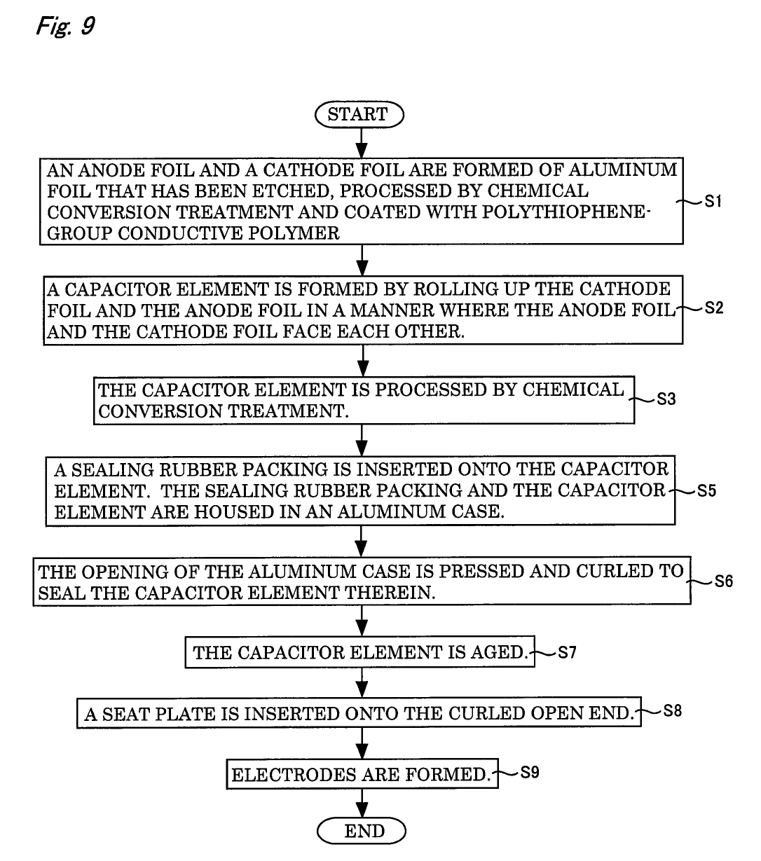

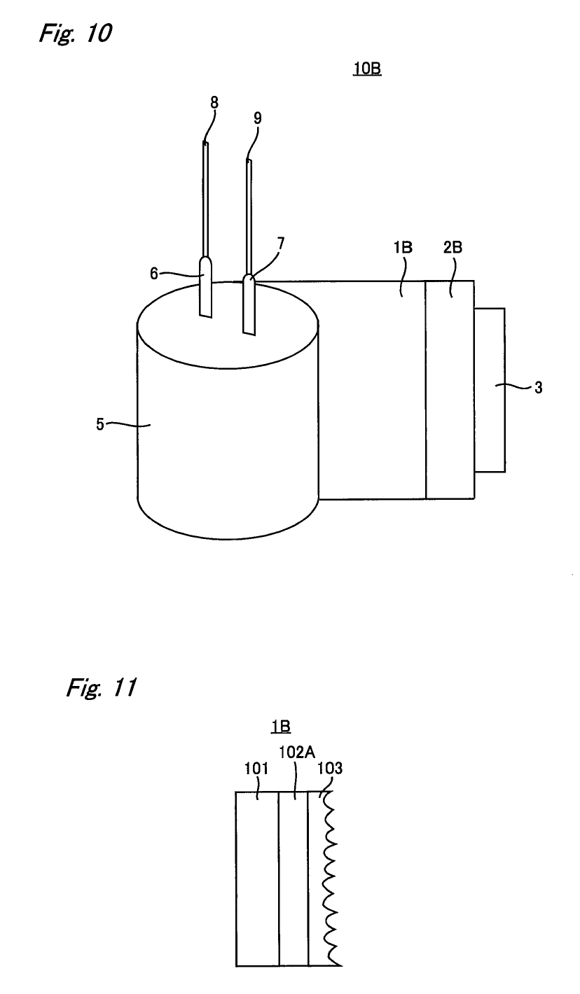

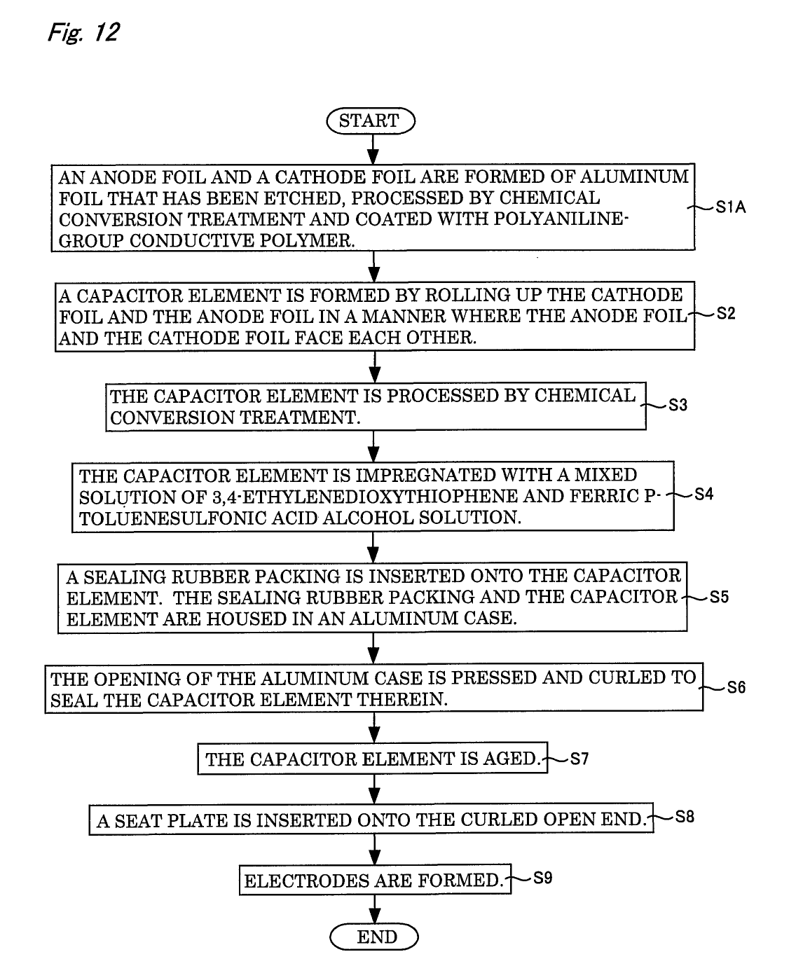

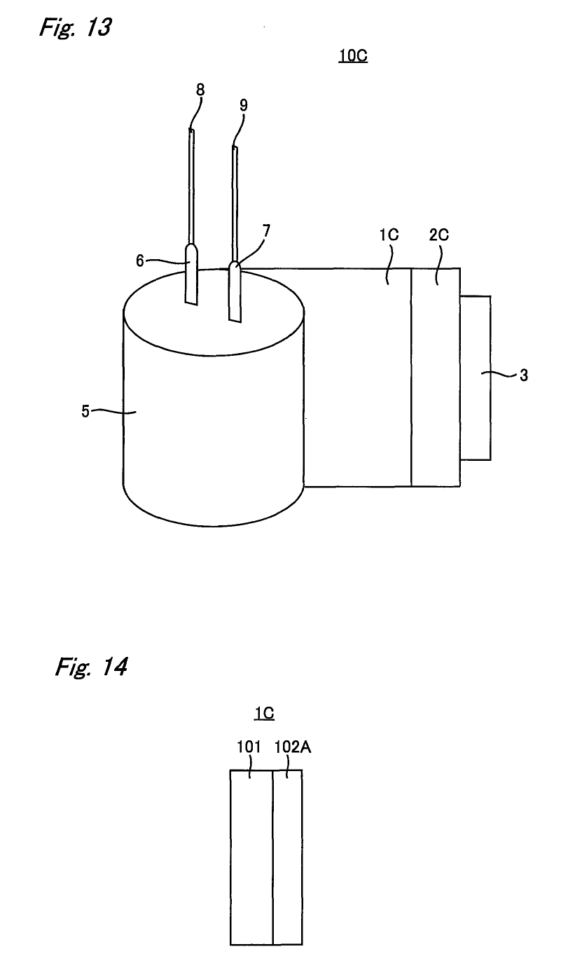

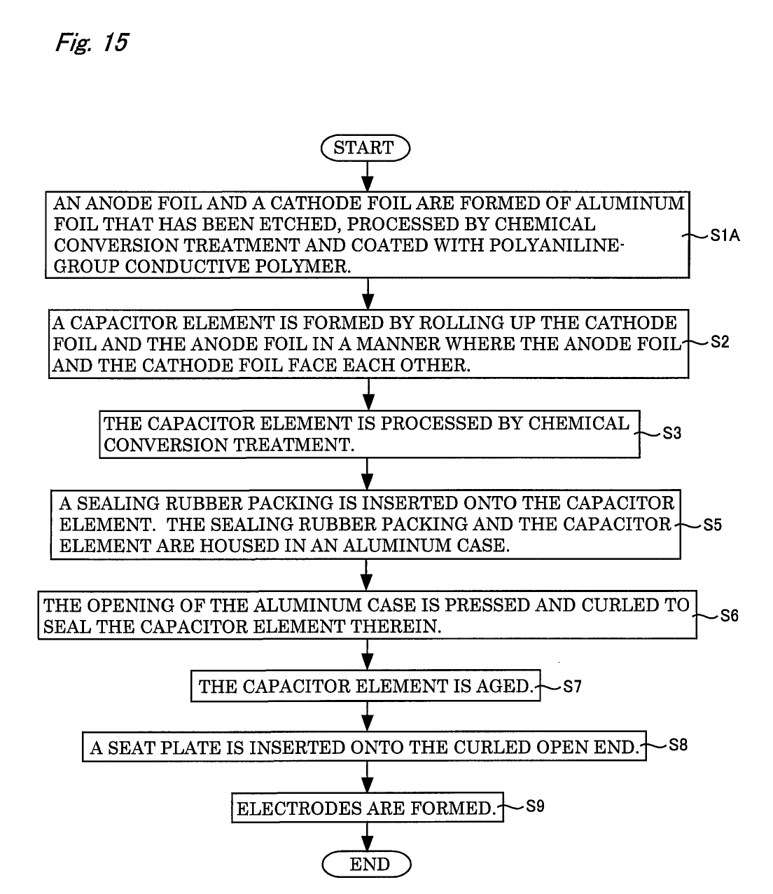

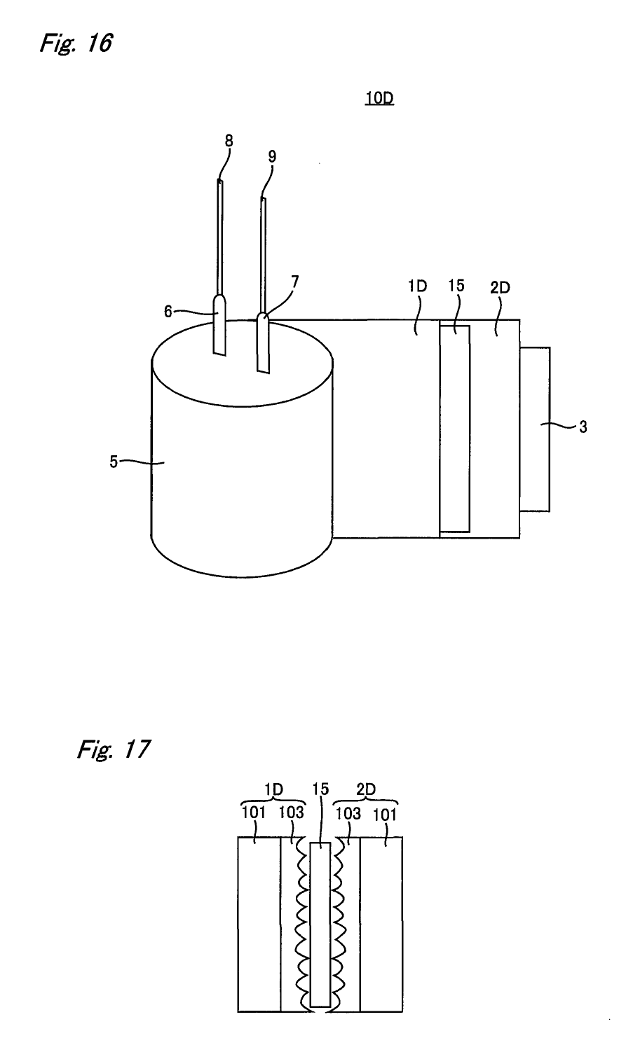

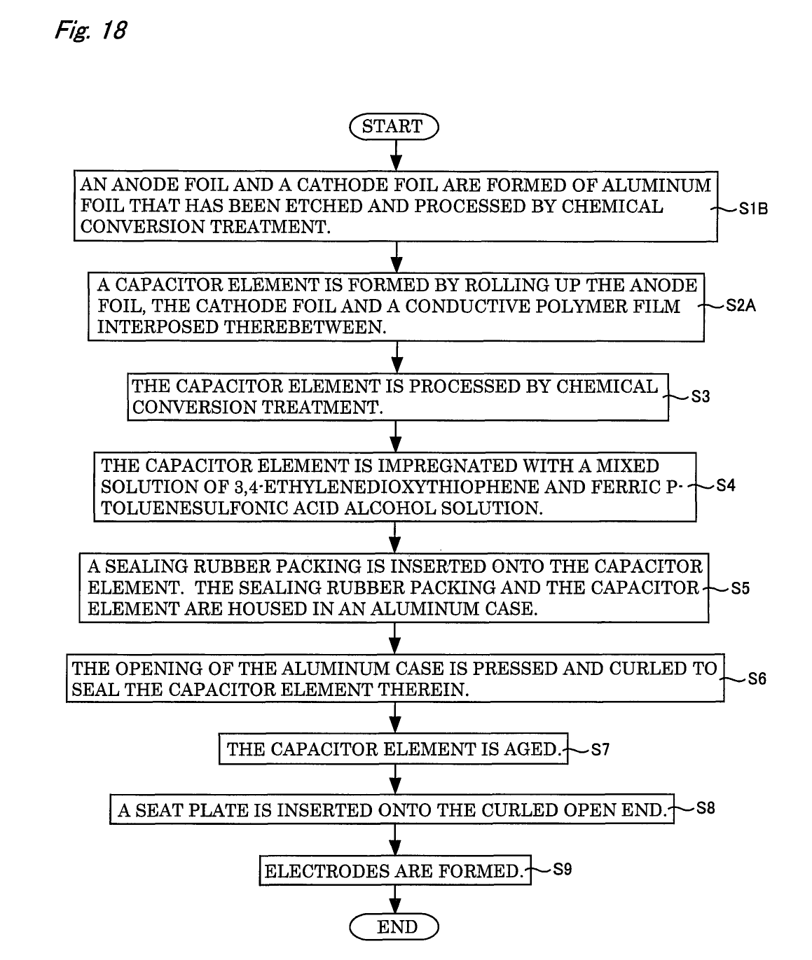

### EXPLANATION OF THE REFERENCE CHARACTERS

1, 1A, 1B, 1C, 1D: Oxidized Anode Foil; 2, 2A, 2B, 2C, 2D: Cathode Foil; 3: Securing Tape; 5: Capacitor Element; 6, 7: Lead Tab Terminal; 8: Anode Lead; 9: Cathode Lead; 10, 10A, 10B, 10C, 10D: Electrolytic Capacitor; 11: Housing; 12: Sealing Rubber Packing; 13: Seat Plate; 13A, 13B: Cutout; 15: Conductive Polymer Film; 101: Metal Foil; 102, 102A, 103: Conductive Polymer Layer.

1. An electrolytic capacitor comprising:
an anode member; and
a cathode member rolled up with the anode member without interposing a separator sheet therebetween.

2. A winding electrolytic capacitor comprising no separator sheet, the electrolytic capacitor comprising:
an anode member whose surface is coated with conductive polymer; and
a cathode member whose surface is coated with conductive polymer; wherein the anode member and the cathode member are rolled up together.

3.-10. (canceled)

11. The electrolytic capacitor according to claim 2, wherein the conductive polymer is formed of at least one of aliphatic-group, aromatic-group, heterocyclic-group and heteroatomic-group conductive polymers.

12. The electrolytic capacitor according to claim 2, further comprising a conductive polymer layer formed between a gap.

13. The electrolytic capacitor according to claim 12, wherein the conductive polymer is formed of at least one of aliphatic-group, aromatic-group, heterocyclic-group and heteroatomic-group conductive polymers.

14. An electrolytic capacitor comprising:
an anode member;
a cathode member rolled up with the anode member; and
a conductive polymer film disposed between the anode member and the cathode member, wherein the anode member, the cathode member and the conductive polymer film are rolled up together.

15. A method of making an electrolytic capacitor, comprising:
a first step of making an anode member and a cathode member; and
a second step of rolling up the anode member and the cathode member without interposing a separator sheet therebetween.

16. A method of making an electrolytic capacitor, comprising:
a first step of making an anode member and a cathode member by coating a surface of metal foil with conductive polymer; and
a second step of rolling up the anode member and the cathode member in a manner where the cathode member and the anode member face each other.

17. The method of making an electrolytic capacitor according to claim 16, further comprising a third step of forming a conductive polymer layer in a gap after the second step.

18. The method of making an electrolytic capacitor according to claim 16, further comprising a third step of impregnating with an electrolyte after the second step.

19. A method of making an electrolytic capacitor, comprising:
a first step of making an anode member and a cathode member; and
a second step of rolling up the anode member, a conductive polymer film and the cathode member in a manner where the cathode member and the anode member face each other across the conductive polymer film.

20. The method of making an electrolytic capacitor according to claim 19, further comprising a third step of forming a conductive polymer layer in a gap after the second step.

21. The method of making an electrolytic capacitor according to claim 19, further comprising a third step of impregnating with an electrolyte after the second step.
